(19) United States
(12) Patent Application Publication
(10) Pub. No.: US 2008/0212150 A1
(43) Pub. Date: Sep. 4, 2008

(54) Digital Document Capture and Storage System

(75) Inventors: Joachim Bremm, Zell (DE); Eric Rietzke, Oberthal (DE)

Correspondence Address: CONLEY ROSE, P.C.;David A. Rose, P. O. BOX 3267, HOUSTON, TX, 77253-3267, US

(73) Assignee: SILVERCRATIONS SOFTWARE AG, Hoppstadten-Weiersbach (DE)

(21) Appl. No.: 12/090,036

(22) PCT Filed: Oct. 12, 2006
(86) PCT No.: PCT/DE06/01845

§ 371 Date: Apr. 11, 2008

(30) Foreign Application Priority Data
Oct. 12, 2005 (DE) 10 2005 049 338.6

(51) Int. Cl. H04N 1/195

(52) U.S. Cl. 358/488

(57) ABSTRACT

The invention relates to a digital document acquisition and storage system, comprising a stand with a support arm hinged thereto and a digital camera, which has an image acquisition area that can be displayed by means of an optical positioning aid and is connected to an electronic data processing device. The aim of the invention is to develop a digital document acquisition and storage system with which it is easy to precisely align the document during reading for electronic acquisition, resulting in a file which gives a qualitative representation of the document which largely matches that of the original. The aim is achieved using a system in which the digital camera has a resolution of at least two million pixels and the optical positioning aid is a single laser which, using a lens, displays a border of the image acquisition area with four guide edges.

### CROSS REFERENCE TO RELATED APPLICATIONS

The present application claims priority to co-pending PCT Application Serial No. PCT/DE2006/001845, filed Dec. 10, 2006, and entitled “Digital Document Acquisition And Storage System,” and also to co-pending German Application Serial No. DE 10 2005 049 338.6, filed Dec. 10, 2005, and entitled “System Zur Digitalen Dokumentenerfassung Und-Speicherung,” both of which are hereby incorporated by reference.

### BACKGROUND

The invention relates to a digital document capture and storage system comprising a stand with a support arm hinged thereto and a digital camera which has an image capture area that can be displayed by means of an optical positioning aid and is connected to an electronic data processor. Likewise covered by the invention is use of an optical positioning aid.

Such systems also find application as document management systems intended to handle filing and administration of correspondence fully electronically. For this purpose it is necessary to capture all paper items of correspondence and to create an electronically storable data file format. One known method of electronic document capture is scanning in which the document is scanned linearly capturing the document line by line in sequence.

In the past it was attempted to incorporate electronic document capture in a central office scanning station. Because of the relatively long time involved in processing there is the drawback of having to wait several days for the data file being made available after having handed over the document for scanning. In most branches of business this delay is intolerable.

As an alternative, there is also the possibility of each workplace having its own scanner so that incoming documents can be scanned as soon as they have been read. Since immediate scanning is often not possible because of the time not being instantly available, the documents to be scanned are often first shelved and sometimes get lost. Because of it being so slow, scanning technology in conjunction with document management system has become more or less obsolete.

In addition to scanning documents for archiving purposes it is also known, for example, in the scope of lectures, to place documents on an image capture device and to show the image enlarged via a display or projector.

A known image capture device is disclosed in DE 102 04 660 A1 comprising a base with an adjustable support arm ending in articulated cone. Mounted at the front end of the cone is a central image sensor to capture an image of an object. The signal generated by the image sensor is communicated to a display, for example a projector, and can also be connected to a write/read storage to store the signals. For a better location of the object in the image capture area at least one lamp is assembled within the rim of the cone for demarcating the image capture area.

The known image capture devices for connecting to a projector usually include an image sensor having a resolution of approx. 300,000 pixels as is sufficient for the intended application. This is, however, not enough for electronic document capture. In addition to this, prior art optical positioning aids are unsuitable for document capture. Where a sole lighting source is used, its illumination is shut down to a rectangular surface area corresponding to the image capturing area. This results in a punctiform concentration of the light within the image capturing area negatively affecting the quality of the document as “seen” by the camera. Especially glossy paper causing reflections detriments the quality of the image. Arranging four sources of light distributed around the edge of the cone, proposed as an alternative, merely displays the corners of the image capturing area and thus not influencing the surface of the document. A drawback with this is that it is difficult to register the document during reading between the displayed corners of the image capturing area.

### SUMMARY

The object of the invention is thus to develop a digital document capture and storage system which now makes it possible to simply precisely register a document for electronic capture already during reading in thereby generating a data file representing the document with high fidelity.

This object is achieved by a system in which the digital camera has a resolution of at least two million pixels and the optical positioning aid is a single laser which by means of an optical assembly displays a border of the image capture area with four demarcation edges.

### BRIEF DESCRIPTION OF THE FIGURES

For a detailed description of illustrative embodiments of the invention, reference will now be made to the accompanying drawings, in which:

FIG. 1 shows a side view in perspective of a system in an operational readiness position with the positioning aid ON, in accordance with at least some illustrative embodiments;

FIG. 2 shows a diagrammatic view of the first and second switch connected in series, in accordance with at least some illustrative embodiments;

FIG. 2b shows a diagrammatic view of the first and second switch as an alternative to that of as shown in FIG. 2a, in accordance with at least some illustrative embodiments; and

FIG. 3 shows an illustration of a framing border of the image capture area with four demarcation edges, in accordance with at least some illustrative embodiments.

The reference numerals shown in the drawings refer to the following elements of the embodiments described:

1 stand

2 support arm

3 digital camera

4 optical positioning aid

5 image capture area

6 data processor

7a-d demarcation edges

8 underside of support arm

9a-b apertures

10 ramped base

11 position sensor

12 first switch

13 second switch

14 hinge

15 stand base

16 column

17 column face

18 column recess

19 ramped flat

20 arrowheads

### DETAILED DESCRIPTION

Document capture is done by means of a digital camera which unlike a scanner provides instant capture of all pixels, speeding up document capture by a multiple over known scanner technologies. Capture quality is further enhanced by making use of a digital camera having a resolution of, for example, 3.5 million pixels.

The digital camera works under normal office ambient light conditions, it requiring no additional light source for document capture. Using a single laser with a holographic optical assembly now achieves, for one thing, a high-contrast display of the demarcation edges of the image capture area even under normal daylight conditions without, for another, influencing the image capture area so that the digital camera, optimized to ambient light, images the document free of reflection irrespective of its surface optical properties.

Preferably the digital camera and the optical positioning aid are arranged system-inherent in the support arm resulting in the advantage that the operator can now very quickly register the support arm orthogonally and thus also the digital camera and the optical positioning aid relative to the document to be imaged.

It has proven to be particularly favorable when the pivoting angle of the support arm is limited relative to the stand by a stopper which when attained, means that the support arm is in its operational readiness position.

Pivoting the support arm can be done either manually or by means of a spring-loaded member, it being particularly in the second alternative that arresting the support arm is to be provided by means of which the support arm is releasably attached in the collapsed condition of the stand.

Since both the digital camera and the optical positioning aid are disposed fixed in position relative to each other, the actual image capture area is automatically displayed. In case the distance between the document and the digital camera should become less, for example, resulting in only a smaller actual image capture area being available, the image capture area displayed by the optical positioning aid is reduced in size to the same degree.

The data processor may comprise thereon an optical character recognition (OCR) software for exceptionally high quality storage of written documents since the raw data is converted into fair copy irrespective of any pixel errors.

Preferably arranged on the underside of the support arm are apertures for the digital camera and the optical positioning aid. This makes it possible to fit the digital camera and the image capture area within the support arm obviating damage to the components precisely set to each other. Another positive aspect of this is that it saves space since the digital camera and the optical positioning aid do not need to be housed separately, the support arm instead serving this purpose.

Said apertures may be provided in a ramped flat of a ramped base, the ramped flat being registered horizontal when the support arm is in its operational readiness position. This additionally simplifies registering the support arm since the operator merely needs to set the ramped flat parallel to a desk or document surface to be imaged.

To advantage the support arm is formed as a rigid hollow profile. For one thing, this hollow profile permits a rugged stability of the support arm, whilst, for another, permitting the wiring of the digital camera and the optical positioning aid to be integrated in the support arm.

In one advantageous embodiment the support arm is pivotable exclusively in a single motion plane relative to the stand. When the support arm is collapsed on to the stand the system is exceptionally compact. For document capture all the operator needs to do is to swing the support arm with the digital camera and the optical positioning aid into the operational readiness position. Because of it being pivotable exclusively in a single motion plane the support arm has no additional degrees of freedom so that the operator very easily finds the operational readiness position.

For document capture and storage the digital camera should feature a constant focal length. This too, further enhances comfortable operation whilst speeding up imaging, especially since the distance between the digital camera and the document underneath is practically constant.

Advantageously arranged on the support arm is a position sensor automatically sensing the operational readiness position of the support arm as a function of the aperture angle to the stand. Combining the position sensor with a first switch permits ON/OFF actuation of the positioning aid and the digital camera, for example.

This position sensor can also be connected to the data processor. In this embodiment the position sensor has the further function of starting a program installed on the data processor, for example an OCR program.

A program can then be run on the data processor in cooperation with a second switch, resulting in the advantage that system operating inputs can be provided within the program requiring, for example, no activation of the digital camera or of the optical positioning aid by the operator. The second switch would then be open-circuited by the data processor as would also be the case if the program crashes.

When the first and second switches are closed the positioning aid is favorably ON when the support arm is in an operational readiness position and the data processor including its program is ready for document capture and storage.

Preferably the positioning aid is OFF when the first and/or second switch is/are open, because when the system is not in operational readiness for data acquisition no display of the image capture area is needed. In particular the optical positioning aid is OFF when the support arm is folded from the operational readiness position down to the stand.

Likewise protected by the invention is use of a positioning aid comprising a single laser which by means of an optical assembly displays a border of the image capture area with four demarcation edges for digital document storage

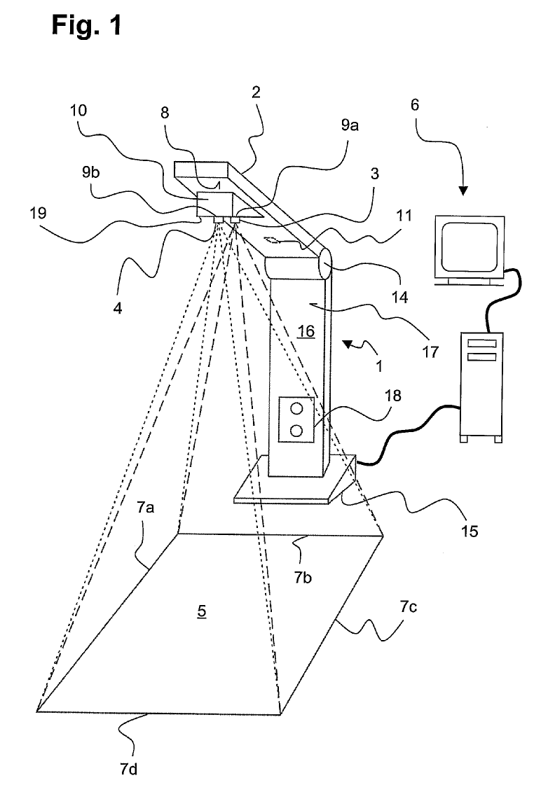

Referring now to FIG. 1 there is illustrated in a side view in perspective a system for digital document capture and storage comprising a stand 1, a support arm 2 pivot-mounted thereon by a hinge 14 and a data processor 6 connected to the stand 1.

The support arm 2 carries at its end remote from the hinge 14 a digital camera 3 and an optical positioning aid 4 located centered in line axially. For this purpose configured on the underside 8 of the support arm 2 there is a ramped base 10, the ramped flat 19 of which is provided with apertures 9a, 9b, the digital camera 3 extending through the aperture 9a and the positioning aid 4 through the aperture 9b.

The stand 1 comprises a stand base 15 connected integrally to a column 16 extending upright essentially perpendicularly. The column 16 is formed as a rectangular profile, the column face 17 of which has a column recess 18 for mounting the ramped base 10 arranged at the support arm 2. The articulated mounting of the support arm 2 at stand 1 permits the system to be folded so that the underside 8 of the support arm 2 fully contacts the stand 1 and the ramped base 10 can dip into the column recess 18, resulting in a highly compact configuration when folded.

In the operational readiness position of the system as shown, the base 15 of the stand 1 stands on a surface (not detailed), for example of a desk. The support arm 2 has achieved its operational readiness position when the ramped flat 19 is arranged parallel to the surface. It is on this surface that an image capture area 5 of the digital camera 3 is displayed by means of four demarcation edges 7a-d for document capture from the optical positioning aid 4. The fanned beams of the actual image capture area of the digital camera and of the optical positioning aid 4 are indicated as broken lines which meet in the demarcation edges 7a-d. As shown in FIG. 1 the demarcation edges 7a-d meet in a closed rectangle, neither the surface outside of the demarcation edges 7a-d nor the framed image capture area 5 being illuminated by the optical positioning aid 4 and thus being optically influenced.

Whether the support arm 2 is unfolded, in other words in the operational readiness position, is sensed by means of a position sensor 11 for which capacitive or inductive working inclination sensors can be used. The position sensor 11 is located concealed within the support arm 2.

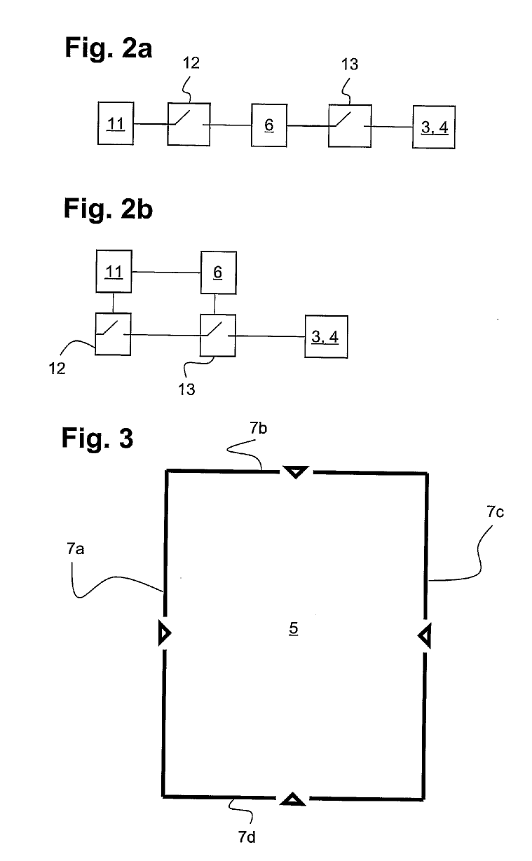

Referring now to FIG. 2a there is illustrated diagrammatically an assembly connected in series of the position sensor 11, a first switch 12, the data processor 6, a second switch 13 and the digital camera 3 as well as the optical positioning aid 4 connected in series, both switches 12, 13 being in an opened position, for example.

The first switch 12 is closed system-inherently when the support arm 2 (see FIG. 1) with its position sensor 11 is in its operational readiness position. The second switch 13 is in contact with the data processor 6 by which, or by the software involved, it is controlled.

Connecting the first and second switch 12, 13 in series results in an AND logic, i.e. the digital camera 3 and the optical positioning aid 4 are automatically ON when the remaining system components are in operational readiness.

Referring now to FIG. 2b there is illustrated an alternative circuit arrangement of the position sensor 11 which, for one thing, activatingly controls the first switch 12 and, for another, furnishes an input signal to the data processor 6 irrespective of the switch position of the first switch 12, the data processor 6 then activatingly controlling the second switch 13 and this in turn the digital camera 3 and the optical positioning aid 4.

Referring now to FIG. 3 there is illustrated a top-down view of the image capture area 5 rendered visible by the four demarcation edges 7a-d. The demarcation edges 7a-d are interrupted by arrowheads 20 which, starting from each demarcation edge 7a-d, are directed at the image capture area 5, serving to assist the user by expediting registering the document to be captured.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1-15. (canceled)

16. A digital document capture and storage system comprising:
a stand comprising a support arm hinged thereto; and
a digital camera comprising an image capture area that can be displayed using an optical positioning aid, and which is coupled to an electronic data processor;
wherein the digital camera has a resolution of at least 2 million pixels and the optical positioning aid comprises a single laser which, by means of an optical assembly, displays a border of the image capture area with four demarcation edges.

17. The system as set forth in claim 16, wherein the electronic data processor comprises thereon optical character recognition (OCR) software.

18. The system as set forth in claim 16, wherein the digital camera and the optical positioning aid are fixedly located in the support arm.

19. The system as set forth in claim 18, wherein the electronic data processor comprises thereon optical character recognition (OCR) software.

20. The system as set forth in claim 16, wherein arranged on the underside of the support arm are apertures for the digital camera and the optical positioning aid.

21. The system as set forth in claim 20, wherein the apertures are provided in a ramped flat of a ramped base, the ramped flat being registered horizontal when the support arm is in an operational readiness position.

22. The system as set forth in claim 16, wherein the support arm is formed as a rigid hollow profile.

23. The system as set forth in claim 16, wherein the support arm is pivotable exclusively in a single motion plane relative to the stand.

24. The system as set forth in claim 16, wherein the digital camera features a constant focal length.

25. The system as set forth in claim 16, wherein arranged on the support arm is a position sensor.

26. The system as set forth in claim 25, wherein the position sensor is coupled to the data processor.

27. The system as set forth in claim 25, wherein the position sensor cooperates with a first switch.

28. The system as set forth in claim 27, wherein a program executes on the data processor, the program cooperating with a second switch.

29. The system as set forth in claim 28, wherein the optical positioning aid is ON when the first and second switches are closed.

30. The system as set forth in claim 28, wherein the positioning aid is OFF when the first and second switch are open.

31. The system as set forth in claim 28, wherein the positioning aid is OFF when either the first or second switch is open.
